(19) United States
(12) Patent Application Publication
(10) Pub. No.: US 2025/0184215 A1
(43) Pub. Date: Jun. 5, 2025

(54) System and Methods for Improving Performance in a Local Area Network Using DHCP Parameters Update Message Network Service

(71) Applicant: QUALCOMM Incorporated, San Diego, CA (US)

(72) Inventors: Vidya Sagar Rao SAMINENI, Hyderabad (IN); Gnana Swaroopa BHANUMUKKALA, Nandyal (IN); Venkatram BODANAM, Hyderabad (IN)

(21) Appl. No.: 18/527,513

(22) Filed: Dec. 4, 2023

(51) Int. Cl. H04L 41/0803

(52) U.S. Cl. CPC H04L 41/0803

(57) ABSTRACT

Methods improve operations of wired and/or wireless access points equipped with a DHCP server function supporting wireless communication with wireless communication devices coupled to a local area network. Various embodiments may include determining that one or more network configuration parameters has been updated, and in response asynchronously sending a network configuration parameters update to one or more attached communication devices that provides the changed one or more network configuration parameters. Automatically updating network configuration parameters in connected communication devices enables communications to continue without the need for detaching and reattaching the communication devices.

### BACKGROUND

Local area wired and/or wireless communication networks have become a standard feature in most households and businesses. For example, typical home wired and/or wireless routers provide convenient connections to the Internet, enabling multiple end-point communication devices, including smartphones, computers, smart televisions and landline telephones, to access the world wide web and place Voice-over-Internet Protocol (VOIP) calls. Such devices can connect to such wireless networks upon receiving/sending signals from/to the router without manual intervention using a communication protocol known as Dynamic Host Configuration Protocol (DHCP). The DHCP mechanisms connect communication devices to a local area network by providing communication devices with basic network configuration parameters. Many of these parameters remain constant, but some parameters change from time to time, such as maximum transmission unit (MTU) size and Session Initiation Protocol (SIP) server information. When such changes occur, connected communication device may not be able to communicate with the network until provided with the changed network configuration parameters.

### SUMMARY

Various aspects include methods, and a local area wired and/or wireless access point including a DHCP server implementing such methods for configuring one or more communication devices communicatively coupled to a network when there is a change in network configuration parameters. Various aspects may include determining that one or more network configuration parameters have been updated, asynchronously sending a network configuration parameters update to one or more attached communication devices including the changed one or more network configuration parameters, and communicating with the attached communication devices using the changed one or more network configuration parameters. In some aspects, the one or more network configuration parameters is one or more of V4 Internet Protocol (IP), Netmask, lease time, time zone, domain name system (DNS) server, maximum transmission unit (MTU), or Session Initiation Protocol (SIP) server info.

In some aspects, the one or more network configuration parameters is one or more of V4 Internet Protocol (IP), Netmask, lease time, time zone, domain name system (DNS) server, maximum transmission unit (MTU), or Session Initiation Protocol (SIP) server info. In some aspects, the updated one or more network configuration parameters may include updated SIP server information received from a remote server.

Some aspects may further include receiving an updated MTU network parameter, and determining whether the updated MTU network parameter requires a change to one or more communication devices, in which asynchronously sending a network configuration parameters update to one or more communication devices attached to the local area network is performed in response to determining that the updated MTU network parameter requires a change to one or more communication devices, and the updated one or more network configuration parameters is the updated MTU network parameter.

In some aspects, asynchronously sending the network configuration parameters update to communication devices attached to the local area network may include sending a single command to all communication devices attached to the local area network. In some aspects, the network configuration parameters update may include a DHCP ACK message.

In some aspects, asynchronously sending the network configuration parameters update may include sending a broadcast message for reception by all communication devices attached to the local area network.

In some aspects, the network configuration parameters update may be sent using a connection between the DHCP server and the one or more communication devices attached to the local area network, the connection including at least one of a wireless communication link, an Ethernet link, or a universal serial bus (USB) link.

In some aspects, asynchronously sending a network configuration parameters update to one or more communication devices attached to the local area network may include sending a network message configured to cause the one or more communication devices attached to the local area network to initiate a Discover, Offer, Request and Acknowledgement (DORA) connection process with the DHCP server, and responding to the DORA connection process to asynchronously send the network configuration parameters update to the one or more communication devices attached to the local area network.

Various aspects also include a DHCP server having a processing system configured to perform any of the method operations summarized above. Various aspects also include a non-transitory processor-readable medium on which is stored processor-executable instructions configured to cause a processor of a DHCP server to perform operations of any of the methods summarized above. Various aspects also include a DHCP server having means for performing functions of the methods summarized above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features herein.

FIG. 1 is a communication system block diagram of a communication network suitable for use with various embodiments.

FIG. 2 is a component block diagram illustrating a processing system for a wireless communication device suitable for implementing various embodiments.

FIG. 3 is a diagram illustrating an example of a software architecture including a radio protocol stack for the user and control planes in wireless communications suitable for implementing various embodiments.

FIG. 4 is a component block diagram illustrating a system for supporting wired and/or wireless local-area network management in accordance with various embodiments.

FIG. 5 is a component block diagram of an example wireless local-area network suitable for using wired and/or wireless local-area network management in accordance with various embodiments.

FIG. 6 is a message flow diagram illustrating various operations that may occur in a conventional wired and/or wireless local area network.

FIG. 7 is a message flow diagram illustrating various operations for supporting wired and/or wireless local-area network management in accordance with various embodiments.

FIG. 8 is a process flow diagram illustrating a method for supporting wired and/or wireless local-area network management in accordance with various embodiments.

FIG. 9 is a process flow diagram illustrating another method for supporting wired and/or wireless local-area network management in accordance with various embodiments.

FIG. 10 is a process flow diagram illustrating another method for supporting wired and/or wireless local-area network management in accordance with various embodiments.

FIG. 11 is a process flow diagram illustrating another method for supporting wired and/or wireless local-area network management in accordance with various embodiments.

FIG. 12 is a component block diagram of a wireless router device suitable supporting wired and/or wireless local-area network management in accordance with various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various embodiments include methods and DHCP servers configured to implement to methods for updating communication devices connected to a wired and/or wireless local network with updated network configuration parameters when such parameters change. Embodiment methods enable communication devices to be updated when there are changes to network configuration parameters, avoiding communication issues that can arise when a network parameter changes while communication devices are connected to but not actively communicating with the network.

The term “communication device” is used herein to refer to any of a variety of computing devices equipped and configured to communicate via a wired and/or wireless network. Nonlimiting examples of communication devices include wired and/or wireless router devices, smart appliances, cellular telephones, smartphones, portable computing devices, personal or mobile multimedia players, laptop computers, tablet computers, smart books, ultrabooks, palmtop computers, wireless electronic mail receivers, multimedia Internet-enabled cellular telephones, medical devices and equipment, biometric sensors/devices, wearable devices (including smart watches, smart clothing, smart glasses, smart wrist bands, smart jewelry, smart rings, smart bracelets, etc.), entertainment devices (e.g., wired and/or wireless gaming controllers, music and video players, satellite radios, etc.), wired and/or wireless-network enabled Internet of Things (IoT) devices including smart meters/sensors, industrial manufacturing equipment, large and small machinery and appliances for home or enterprise use, wireless communication elements within vehicles, wireless devices affixed to or incorporated into various mobile platforms, and similar electronic devices that include a memory, wired and/or wireless communication components, and a programmable processor.

The terms “wireless network,” “cellular network,” and “cellular wireless communication network” are used interchangeably herein to refer to a portion or all of a wireless network of a carrier associated with a wireless device and/or subscription on a wireless device.

The terms “access point” or “AP” encompasses a device that serves as a point of logical connection in a local area network for computing devices such as laptop computers, notebook computers, PDAs, VoIP phones and dual network (cellular plus Wi-Fi) phones. A typical AP may be configured to confirm that a particular communication device is authorized to connect to the network (authentication), manage the encryption and decryption of data packets, and, when configured as router, forwards IP packets from one IP host to another over an arbitrary link. In some embodiments, an access point may provide wired network connections (e.g., Ethernet or Universal Serial Bus (USB) to communication devices connected to a local wired area network. In some embodiments, an access point may provide wireless network connections (e.g., Wi-Fi, Bluetooth®, LTE-direct, etc.) to communication devices connected to a wireless local area network (WLAN). In some embodiments, an access point may provide both wired network connections (e.g., Ethernet or Universal Serial Bus (USB) and wireless network connections (e.g., Wi-Fi, Bluetooth®, LTE-direct, etc.) to communication devices connected to the local area network. An AP may include a server configured to function as a bridge that converts packets from a wired Ethernet frame format into an 802.11 Wi-Fi frame format for transmission in a WLAN.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “multicore processor” may be used herein to refer to a single integrated circuit (IC) chip or chip package that contains two or more independent processing cores (e.g., a central processor unit (CPU) core, Internet protocol (IP) core, graphics processor unit (GPU) core, etc.) configured to read and execute program instructions. A SOC may include multiple multicore processors, and each processor in an SOC may be referred to as a core. The term “multiprocessor” may be used herein to refer to a system or device that includes two or more processing units configured to read and execute program instructions.

Various embodiments enable wired and wireless communications devices to communicatively connect to a wired and/or wireless local-area network in order to access the internet.

Various embodiments may include a Dynamic Host Configuration Protocol (DHCP) server configured to support communication devices connecting to the wired and/or wireless access point in order to connect to a wide area network (WAN) such as the internet. The DHCP server is typically part of a wired and/or wireless access point connecting communication devices on a local area network (LAN) or wireless local area network (WLAN) with remote computing systems connected to a wide area network, for example the internet. Local networks may be referred to herein as a LAN or a WLAN interchangeably as the DHCP protocol may be utilized on wired, wireless and combinations of wired and wireless networks whether a communication device connects to an access point using a wired connection, such and an ethernet, or using a wireless connection such as Wi-Fi, Bluetooth, and similar communication protocols.

The Dynamic Host Configuration Protocol (DHCP) is a network management protocol used on Internet Protocol (IP) networks for automatically assigning IP addresses and other communication parameters to devices connected to the network using a client-server architecture. The DHCP protocol eliminates the need for individually configuring network devices manually, and consists of two network components, a centrally installed network DHCP server and client instances of the protocol stack on each computer or device. When connected to the network, and periodically thereafter, a communication device may request a set of parameters from the server using DHCP.

DHCP can be implemented on networks ranging in size from residential networks to large campus networks and regional Internet service provider (ISP) networks. Many routers, wired and/or wireless access points, and residential gateways have DHCP server capability. Most residential network routers receive a unique IP address within the ISP network. Within a local network, a DHCP server assigns a local IP address to each device.

DHCP services exist for networks running Internet Protocol version 4 (IPv4), as well as version 6 (IPv6). The IPv6 version of the DHCP protocol is commonly called DHCPv6.

Various embodiments may be implemented in a WLAN with a DHCP server enabling multiple client devices to attach to the WLAN via a wired and/or wireless access point (also referred to as a wireless router). The wired and/or wireless access point includes functionality of a DHCP server to support management of the IP addresses and communication connections used by the client devices when attached to the LAN or WLAN.

A DHCP server may support different communications protocols and data times transmitted via the LAN or WLAN. For example, the LAN or WLAN may enable a text-based Hypertext Transport Protocol (HTTP) communications connection between the attached client devices and remote web servers. The LAN or WLAN may enable a VOIP communications connection between the attached client devices and remote computing devices. The LAN or WLAN may enable a streaming media communications connection between the attached client devices and remote streaming media data sources. The LAN or WLAN may enable other communication connections used by client devices communicating with remote computing systems.

To support these various communication connections, the DHCP server maintains one or more network communication configuration parameters that define how communications are accomplished with attached client devices when one of the supported communication connections is established and utilized. These one or more network communication configuration parameters may be specified by remote computing systems where the attached client devices establish a communication connection. These one or more network communication configuration parameters may be specified by the remote computing systems defining a communications path across the wide area network. These network communication configuration parameters are used by these various computing systems to maintain an efficient and functioning communications network capable of supporting all of the communication devices communicating with each other over the wide area network. The network communication configuration parameters may include or more of the following parameters: V4 IP, Netmask, lease time, domain name system (DNS) server, MTU, Session Initiation Protocol (SIP) server information, and other network configuration information to clients using the DHCPv4 mechanism (DORA).

Changes in network communication configuration parameters may occur as the operating conditions and communication loads between nodes within the wide area network change. Currently, the DHCP protocol fails to provide an efficient mechanism for updating network communication configuration parameters on client devices attached to the network without requiring each attached client device to reestablish a connection to the wired and/or wireless access point in the manner utilized each time a client device attaches to a WLAN. As a result, client devices on a network that are not actively engaged in communications (e.g., in a standby or idle connection mode) not be informed of changes in network communication configuration parameters, which may result in loss of communication connections for the client devices of delays in communicating with external networks.

In various embodiments, the DHCP server may be configured to enable network communication configuration parameters to be dynamically changed by the one or more communication devices communicating over the wide area network, and then inform other connected devices of the configuration changes, thereby avoiding issues for connected devices that can arise is connected devices are not informed of the latest configuration parameters. These network communication configuration parameters may be dynamically updated in all communication devices connected to the network so as to manage the performance and functionality of the communication connections established within the wide area network.

When one or more of the network communication configuration parameters is updated for communication connections with one connected device utilizing a particular wired and/or wireless access point, the configuration parameter settings stored in other attached client devices are updated by the DHCP server automatically so that communications by all attached client devices will conform to the corresponding network communication configuration parameters, thereby avoiding the need to reconnect client devices the next time the other attached client devices communicate with the network. Various embodiments may use a network configuration parameters update command that enables a wired and/or wireless access point to automatically update the network configuration parameters used by attached client devices when the wired and/or wireless access point detects a change in a current network configuration parameters.

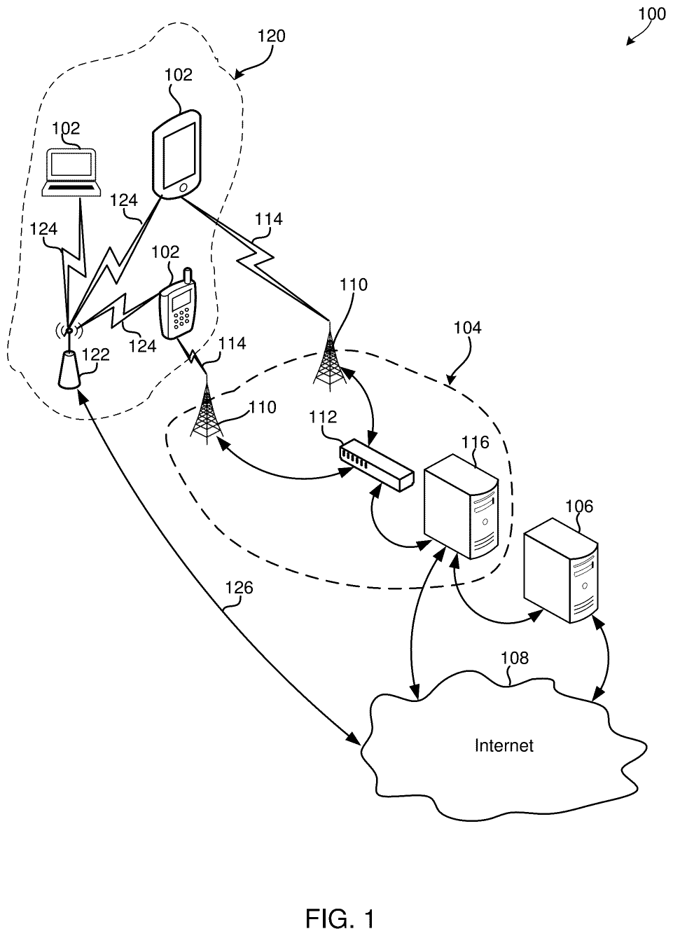

Various embodiments may be implemented within a variety of communication systems, such as the example communication system 100 illustrated in FIG. 1. The communication system 100 may include one or more wired and/or wireless communication devices 102 in communication with a telephone network 104 and a wireless local area network (WLAN) 120.

A WLAN 120 may include a wired and/or wireless access point 122 (e.g., a Wi-Fi “hotspot”) that is coupled to the Internet. A wireless access point 122 supports wireless communication links 124 (e.g., Wi-Fi signals) with wired and/or wireless communication devices 102 that are within communication range and logged into the access point. A wired access point 122 supports wired communication links 124 (e.g., Ethernet, USB, etc.) with communication devices 102 that are connected via wired communication links to the access point. The access point 122 relays packetized communication packets (e.g., TCP/IP packets) between the wired and/or wireless communication devices 102 and the Internet, typically via wired (or fiber optic) networks 126, which may include an Internet service provider or “ISP” (not shown). The wireless communication links 124 provided by the wireless access point 122 constitute a WLAN 120 of connected wired and/or wireless communication devices 102, although some communication devices may be connected to the access point 122 via wired connections providing a LAN. Thus, references herein to WLANs and wireless access points do not exclude wired LAN connects to communication devices.

The telephone network 104 may include network servers 106 coupled to the telephone network 104 and to the Internet 108. A typical telephone network 104 may include a plurality of cell base stations 110 coupled to a network operations center 112, which operates to connect voice and data calls between the wired and/or wireless communication devices 102 (e.g., cellular phones, tablets, laptop computers, etc.) and other network destinations, such as via telephone land lines and the Internet 108. The telephone network 104 may also include one or more servers 116 coupled to or within the network operations center 112 that provide a connection to the Internet 108 and/or to the network servers 106. Communications between the wired and/or wireless communication devices 102 and the telephone network 104 may be accomplished via two-way wireless communication links 114, such as GSM, UMTS, EDGE, fourth generation (4G), 3G, CDMA, TDMA, LTE, and/or other communication technologies.

Upon power up, a wired and/or wireless communication device 102 may search for wireless networks from which the communication device 102 can receive communication service. If a WLAN 120 is detected, the communication devices 102 may exchange handshaking messages with a wireless access point 122 to establish a WLAN communication link 124. The wireless communication device 102 may also search for wireless telephony networks. Communication devices may also or alternatively recognize wired connections (e.g., via an Ethernet or USB cable) to a local area network access point, which may be a wireless access point 122, and exchange handshaking messages to establish wired communication links.

The wired and/or wireless communication device 102 may perform registration processes on one of the identified networks (referred to as the serving network), and the communication device 102 may operate in a connected mode to actively communicate with the serving network. Alternatively, the communication device 102 may operate in an idle mode and camp on the serving network if active communication is not required by the communication device 102. In the idle mode, the communication device 102 may identify all radio access technologies (RATs) in which the wireless communication device 102 is able to find a “suitable” cell in a normal scenario or an “acceptable” cell in an emergency scenario, as specified in the LTE standards, such as 3GPP TS 36.304 version 8.2.0 Release 8, entitled “LTE; Evolved Universal Terrestrial Radio Access (E-UTRA); User Equipment (UE) procedures in idle mode.”

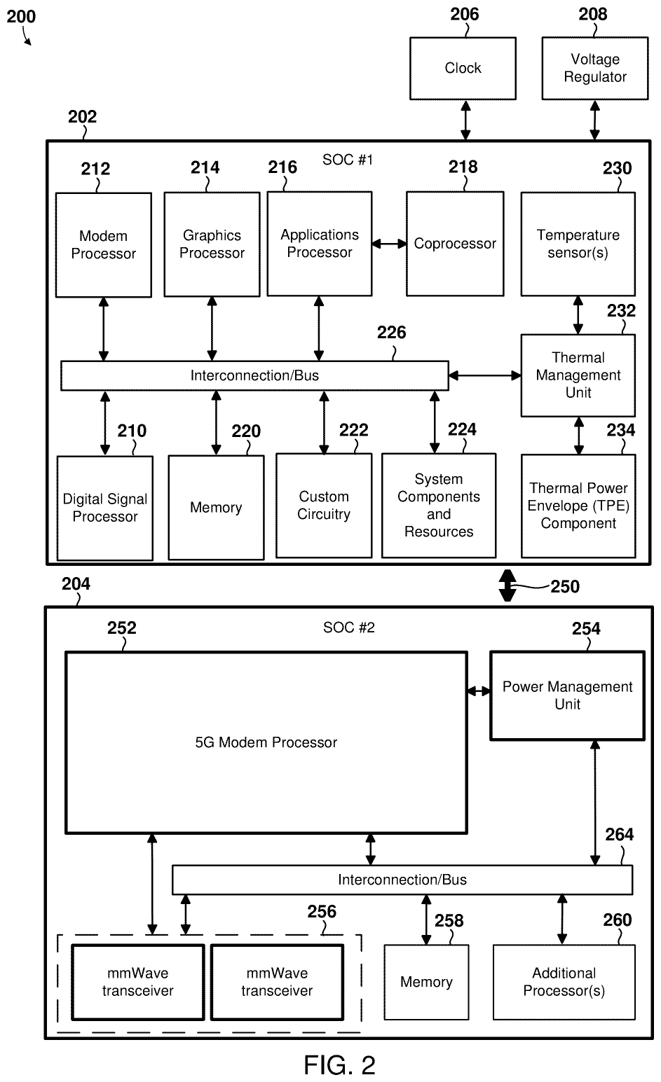

FIG. 2 is a component block diagram illustrating an example of processor and wireless modem components 200 for use in a communication device suitable for implementing any of the various embodiments. Various embodiments may be implemented on a number of single processor and multiprocessor computer systems (e.g., communication device 102), including a system-on-chip (SoC) or system in a package.

With reference to FIGS. 1-2, the illustrated example processor and wireless modem components 200 includes two SoCs 202, 204 coupled to a clock 206, a voltage regulator 208, and a wireless transceiver 266 configured to send and receive wireless communications via an antenna (not shown) to/from network wireless communication devices (e.g., 102). In some embodiments, the first SoC 202 operate as central processing unit (CPU) of the communication device that carries out the instructions of software application programs by performing the arithmetic, logical, control and input/output (I/O) operations specified by the instructions. In some embodiments, the second SoC 204 may operate as a specialized processing unit. For example, the second SoC 204 may operate as a specialized 5G processing unit responsible for managing high volume, high speed (e.g., 5 Gbps, etc.), and/or very high frequency short wavelength (e.g., 28 GHz mmWave spectrum, etc.) communications.

The first SoC 202 may include a digital signal processor (DSP) 210, a modem processor 212, a graphics processor 214, an application processor (AP) 216, one or more coprocessors 218 (e.g., vector co-processor) connected to one or more of the processors, memory 220, custom circuitry 222, system components and resources 224, an interconnection/bus module 226, one or more temperature sensors 230, a thermal management unit 232, and a thermal power envelope (TPE) component 234. The second SoC 204 may include a 5G modem processor 252, a power management unit 254, an interconnection/bus module 264, the plurality of mmWave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SoC 202 may include a processor that executes a first type of operating system (e.g., FreeBSD, LINUX, OS X, etc.) and a processor that executes a second type of operating system (e.g., MICROSOFT WINDOWS 10). In addition, any or all of the processors 210, 212, 214, 216, 218, 252, 260 may be included as part of a processor cluster architecture (e.g., a synchronous processor cluster architecture, an asynchronous or heterogeneous processor cluster architecture, etc.).

The first and second SoC 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SoC 202 may include power amplifiers, voltage regulators, oscillators, phase-locked loops, peripheral bridges, data controllers, memory controllers, system controllers, access ports, timers, and other similar components used to support the processors and software clients running on a wireless communication device. The system components and resources 224 and/or custom circuitry 222 may also include circuitry to interface with peripheral devices, such as cameras, electronic displays, wireless communication devices, external memory chips, etc.

The first and second SoCs 202, 204 may communicate via interconnection/bus module 250. The various processors 210, 212, 214, 216, 218, may be interconnected to one or more memory elements 220, system components and resources 224, and custom circuitry 222, and a thermal management unit 232 via an interconnection/bus module 226. Similarly, the processor 252 may be interconnected to the power management unit 254, the mmWave transceivers 256, memory 258, and various additional processors 260 via the interconnection/bus module 264. The interconnection/bus module 226, 250, 264 may include an array of reconfigurable logic gates and/or implement a bus architecture (e.g., CoreConnect, AMBA, etc.). Communications may be provided by advanced interconnects, such as high-performance networks-on chip (NoCs).

The first and/or second SoCs 202, 204 may further include an input/output module (not illustrated) for communicating with resources external to the SoC, such as a clock 206, a voltage regulator 208, one or more wireless transceivers 266. Resources external to the SoC (e.g., clock 206, voltage regulator 208) may be shared by two or more of the internal SoC processors/cores.

In addition to the example processor and wireless modem components 200 discussed above, various embodiments may be implemented in a wide variety of computing systems, which may include a single processor, multiple processors, multicore processors, or any combination thereof.

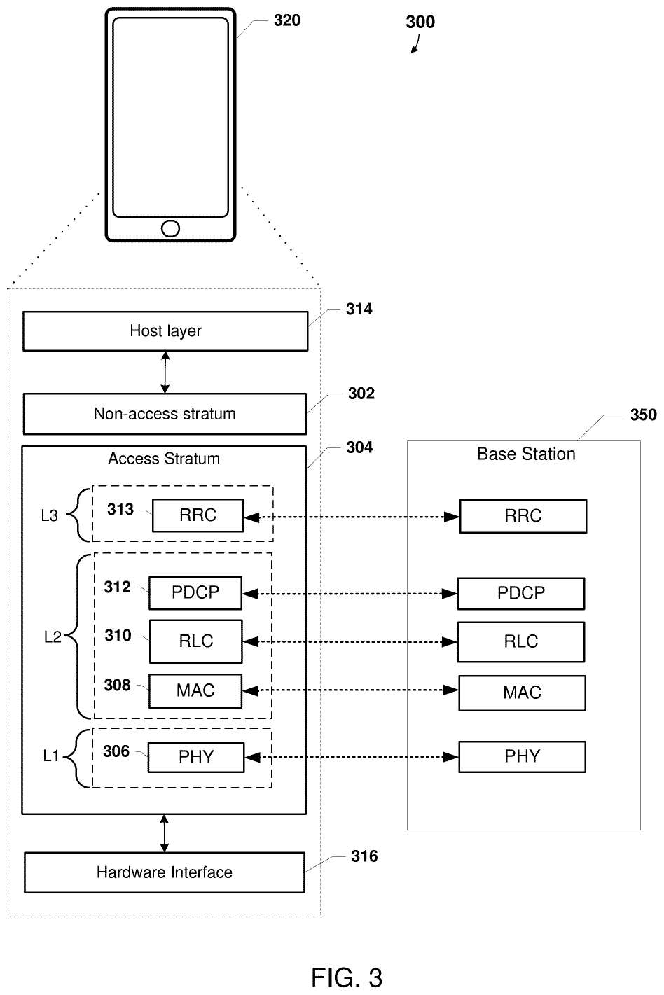

FIG. 3 is a component block diagram illustrating a software architecture 300 including a radio protocol stack for the user and control planes in wireless communication devices suitable for implementing any of the various embodiments. With reference to FIGS. 1-3, the wireless communication device 320 may implement the software architecture 300 to facilitate communication between a wireless communication device 320 (e.g., the wireless communication devices 120a-120e) and the base station 350 (e.g., the base station 110a-d) of a communication system (e.g., 100a, 100b). In some embodiments, layers in software architecture 300 may form logical connections with corresponding layers in software of the base station 350. The software architecture 300 may be distributed among one or more processors. While described below with reference to LTE communication layers, the software architecture 300 may support any of variety of standards and protocols for wireless communications, and/or may include additional protocol stacks that support any of variety of standards and protocols wireless communications.

The software architecture 300 may include a Non-Access Stratum (NAS) 302 and an Access Stratum (AS) 304. The NAS 302 may include functions and protocols to support Packet filtering, security management, mobility control, session management, and traffic and signaling exchanged with a core network 140. The AS 304 may include functions and protocols that support communication with entities of supported access networks. In particular, the AS 304 may include at least three layers (Layer 1, Layer 2, and Layer 3), each of which may contain various sub-layers.

In the user and control planes, Layer 1 (L1) of the AS 304 may be a physical layer (PHY) 306, which may oversee functions that enable transmission and/or reception over the air interface. Examples of such physical layer 306 functions may include cyclic redundancy check (CRC) attachment, coding blocks, scrambling and descrambling, modulation and demodulation, signal measurements, MIMO, etc. The PHY layer 306 may include various logical channels, including the Physical Downlink Control Channel (PDCCH) and the Physical Downlink Shared Channel (PDSCH). As an example, the PHY layer 306 may support CSI measurements and reporting (e.g., CQI measurements and reporting).

In the user and control planes, Layer 2 (L2) of the AS 304 may be responsible for the link between the wireless communication device 320 and the base station 350 over the physical layer 306. In the various embodiments, Layer 2 may include a Media Access Control (MAC) sublayer 308, a Radio link Control (RLC) sublayer 310, and a Packet data convergence protocol (PDCP) 312 sublayer, each of which form logical connections terminating at the base station 350.

In the control plane, Layer 3 (L3) of the AS 304 may include a Radio Resource Control (RRC) sublayer 3. While not shown, the software architecture 300 may include additional Layer 3 sublayers, as well as various upper layers above Layer 3. In various embodiments, the RRC sublayer 313 may provide functions including broadcasting system information, paging, and establishing and releasing an RRC signaling connection between the wireless communication device 320 and the base station 350.

In various embodiments, the PDCP sublayer 312 may provide uplink functions including multiplexing between different Radio bearers and logical channels, sequence number addition, handover data handling, integrity protection, ciphering, and header compression. In the downlink, the PDCP sublayer 312 may provide functions that include in-sequence delivery of data packets, duplicate data Packet detection, integrity validation, deciphering, and header decompression.

In the uplink, the RLC sublayer 310 may provide segmentation and concatenation of upper layer data packets, retransmission of lost data packets, and Automatic Repeat Request (ARQ). In the downlink, while the RLC sublayer 310 functions may include reordering of data packets to compensate for out-of-order reception, reassembly of upper layer data packets, and ARQ.

In the uplink, MAC sublayer 308 may provide functions including multiplexing between logical and transport channels, random access procedure, logical channel priority, and hybrid-ARQ (HARQ) operations. In the downlink, the MAC layer functions may include channel mapping within a cell, de-multiplexing, discontinuous reception (DRX), and HARQ operations.

While the software architecture 300 may provide functions to transmit data through physical media, the software architecture 300 may further include at least one host layer 314 to provide data transfer services to various applications in the wireless communication device 320. In some embodiments, application-specific functions provided by the at least one host layer 314 may provide an interface between the software architecture and the general-purpose processor.

In other embodiments, the software architecture 300 may include one or more higher logical layer (e.g., transport, session, presentation, application, etc.) that provide host layer functions. In some embodiments, the software architecture 300 may include an application layer in which a logical connection terminates at another device (e.g., end user device, server, etc.). In some embodiments, the software architecture 300 may further include in the AS 304 a hardware interface 316 between the physical layer 306 and the communication hardware (e.g., one or more radio frequency (RF) transceivers).

The modem stacks in various embodiments may support any of a variety of current and/or future protocols for wireless communications. For examples, the modem stacks in various embodiments may support networks using radio access technologies described in IEEE standards (WiMAX, Wi-Fi, etc.) and/or 3GPP standards (e.g., GSM, UMTS, LTE, etc.), 3GPP2 standards (e.g., 1×RTT/CDMA2000, EV-DO, UMB, etc.).

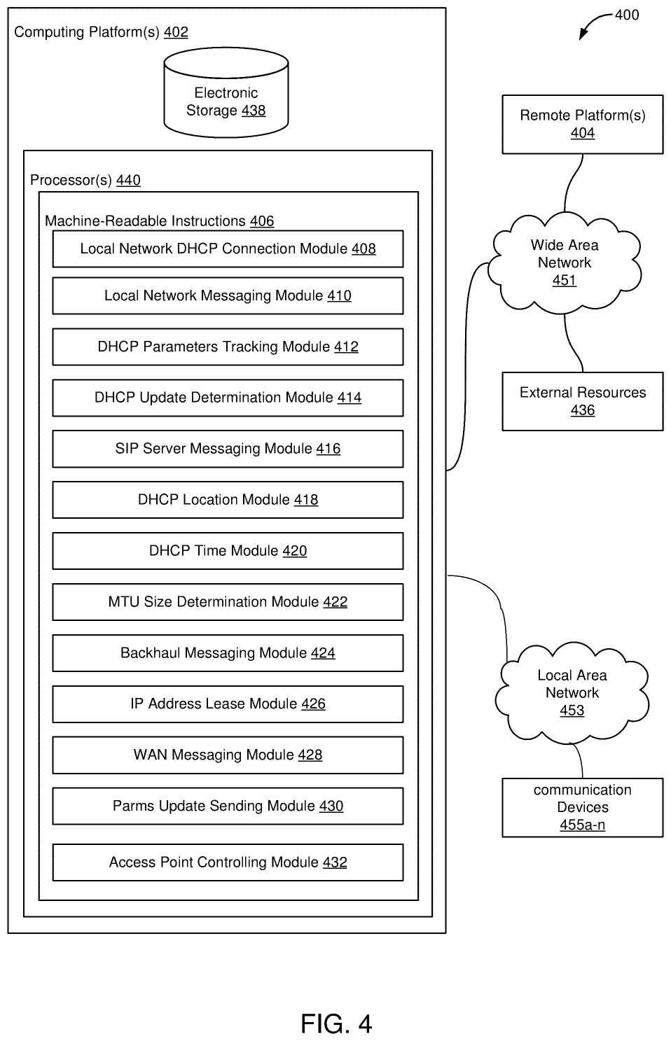

FIG. 4 is a component and software module block diagram illustrating a communication system 400 including a wired and/or wireless access point 402 configured with a DHCP server function for supporting wired and/or wireless local-area network management in accordance with various embodiments. With reference to FIGS. 1-4, a communication system 400 may include a wired and/or wireless access point 402 that supports a local area network 453 coupled to wired and/or wireless communication devices 102. The wired and/or wireless access point 402 may also be configured to communicate with a wide area network 451 for connecting with remote devices 404 and external resources 436.

The wired and/or wireless access point 402 may include a processing system 440 that includes one or more processors (e.g., 210, 212, 214, 216, 218) and supporting circuitry (e.g., 222, 224), electronic storage 438, and a wireless transceiver 403. The processing system 440 may be configured by machine-readable instructions 406, which may be stored in the electronic storage 438 before being loaded into one or more processors for execution. Machine-readable instructions 406 may include one or more instruction modules, which may be computer program modules. The instruction modules may include one or more of a local area network DHCP connection module 408, a local area network messaging module 410, a DHCP parameters tracking module 412, a DHCP update determination module 414, a SIP server messaging module 416, a DHCP location module 418, a DHCP time module 420, a maximum transmission unit (MTU) size determination module 422, a backhaul messaging module 424, an Internet protocol (IP) address lease module 426, a wide area network (WAN) messaging module 428, a parameters (“Parms”) update sending module 430, an access point controlling module 432, and other instruction modules.

The local area network DHCP connection module 408 may be configured to receive connection requests for communication devices 102 to attach to a WLAN 453. The local area network DHCP connection module 408 may collaborate with the IP address lease module 426 to obtain an IP address for use by a client device for communicating over the WLAN 453. The local area network DHCP connection module 408 also may implement user identification and authorization for determining whether a client device is permitted to connect to WLAN 453.

The local area network messaging module 410 may be configured to send and receive data packets with attached communication devices 102. The local area network connection module 410 may collaborate with the WAN messaging module 428 to forward data between attached communication devices 102 and remote platforms 404.

DHCP parameters tracking module 412 may be configured to maintain a current set of network communication configuration parameters used by the one or more communication devices 102 when communicating with the remote platforms 404. In some embodiments, the DHCP parameters tracking module 412 may maintain a set of parameters used by each attached communication device 102. In some embodiments, the DHCP parameters tracking module 412 may maintain a set of communication parameters by communication connection type and/or corresponding remote platform 404. In some embodiments, the DHCP parameters tracking module 412 may maintain a set of communication parameters to be used by all attached client devices. The sets of communication parameters maintained by the DHCP parameters tracking module 412 may be stored within an electronic storage device 428 for use when needed.

The DHCP update determination module 414 may be configured to determine whether one of the current set of network communication configuration parameters in use by one or more of the attached communication devices 102 has changed. The DHCP update determination module 414 also may determine whether the change in communication parameters requires that an update be sent to one or more of the attached communication devices 102.

The SIP server messaging module 416 may be configured to generate and send messages to a SIP server as part of a communication connection between an attached communication device 102 and a remote device 404. The WAN messaging module 428 also may be configured to receive and forward messages from the SIP server as part of a communication connection between an attached client device 102 and remote platforms 404. The SIP server messaging module 416 may perform operations to format and construct data packets as needed to support the communication connection between an attached communication device 102 and the SIP server.

The DHCP location module 418 may be configured to maintain location information associated with the DHCP server, wired and/or wireless access point, and WLAN. This location information may be provided to client devices when attaching to the WLAN as part of a DHCP initiated connection enabling an attached client device to utilize the location information as needed.

The DHCP time module 420 may be configured to maintain local time information associated with the DHCP server, wired and/or wireless access point, and WLAN. This location information may be provided to client devices when attaching to the WLAN as part of a DHCP initiated connection providing an attached client device current time information used by all communication devices 102 attached to the WLAN as needed.

The MTU size determination module 422 may be configured to determine whether a detected MTU size parameter update needs to be updated for one or more of the attached communication devices 102.

The backhaul messaging module 424 may be configured to perform network configuration and management operations via a backhaul communications channel separate from data channels used by communication connections between attached communication devices 102 and remote platforms 404.

The IP address lease module 426 may be configured to create and maintain DHCP IP address leases for each of the attached client devices. The DHCP server may assign an IP address to each attached communication device 102 at the time of connection to the WLAN. The assignment of the IP address is considered a lease for a period of time after which the client device must reconnect to the DHCP server. The expiration of each IP address lease creates an automatic mechanism for retrieving and reusing IP addresses during long periods of inactivity by a client device.

Additionally, communication devices 102 may routinely disconnect from the WLAN, for example when a user leaves a home equipped with a WLAN home network with a smartphone that previously attached to the WLAN and obtained an IP address. When the user returns to the home network with the smartphone, the smartphone may reconnect to the WLAN. If the previously assigned IP address has not been assigned to a new device, the smartphone may use the same IP address. If the WLAN management needed to reuse the IP address while the smartphone was away from the WLAN, as may be required when the WLAN has a large number of attached communication devices and a limited number of available IP addresses, the smartphone may be assigned a new IP address having a new IP address lease.

The WAN messaging module 428 may be configured to generate and send messages to remote platforms 404 as part of a communication connection between an attached communication device 102 and the remote platforms 404. The WAN messaging module 428 also may be configured to receive and forward messages from remote platforms 404 as part of a communication connection between an attached communication device 102 and the remote platforms 404. The WAN messaging module 428 may collaborate with the local area network connection module 410 to forward data between attached communication devices 102 and remote platforms 404.

The Parms update sending module 430 may be configured to generate a network configuration parameters update command to be sent to one or more of the attached communication devices 102. The Parms update sending module 430 also may determine whether the network configuration parameters update command should be sent using a unicast message or a broadcast message. The Parms update sending module 430 may send a generated network configuration parameters update command to one or more of the attached communication devices 102.

The access point controlling module 432 may be configured to control operations of the wired and/or wireless access point including its mode of operation, choice of channels for use in communicating with attached communication devices 102.

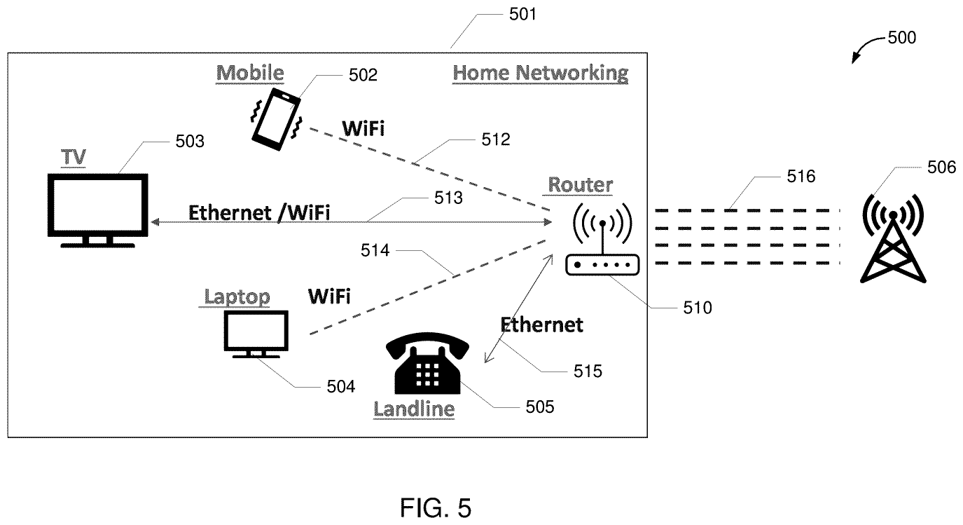

FIG. 5 is a component block diagram of an example WLAN suitable for using wired and/or wireless local-area network management in accordance with various embodiments. With reference to FIGS. 1-5, the WLAN 501 may be created by a wired and/or wireless access point 402 to connect one or more client devices 502-505 to communicate with remote computing systems (not shown) over a wide area network 516 or the internet. Non-limiting examples of various attached communication devices 502-505 may include mobile communication devices 502, 504, smart televisions 503, and landline telephones 505. Each communication device 502-505 may be communicatively coupled to the wired and/or wireless access point 402 by a corresponding communication connection 512-515. These communication connections 512-515 may include wired connections 513, 515, such as ethernet or similar technology, and wireless connections, such as Wi-Fi, Bluetooth, and similar wireless technologies. The remote computing systems may include web servers, streaming media sources, VOIP servers, and wireless communications systems such as cellular communications networks.

The wired and/or wireless access point 402 may include a router that provides a DHCP server that implements the system and methods of various embodiments. The DHCP server also may be hosted in a remote computing system that connects the WLAN 501 with the wide area network.

While the various embodiments describe improving page decode performance network communication operations of communication devices 502-505 communicatively coupled to a wired and/or wireless access point 402, various embodiments may be implemented for DHCP device configuration and management for communication devices 502-505 communicatively coupled to the wired and/or wireless access point 402 both using wireless communications, such as Wi-Fi, Bluetooth, and similar protocols, as well as wired connections such as Ethernet communications.

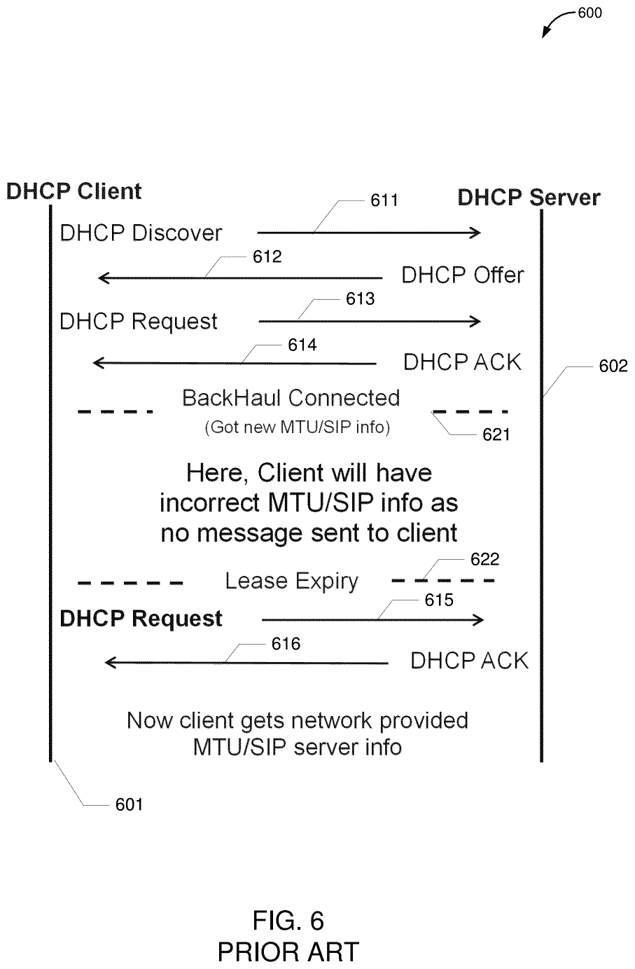

FIG. 6 is a message flow diagram illustrating various operations for supporting wireless local-area network management in accordance with conventional local area networks. With reference to FIGS. 1-6, a message flow between a DHCP client 601 and a DHCP server 602 is shown as the DHCP client connects to a WLAN associated with the DHCP server 602.

A connection attempt may be initiated by a DHCP client device 601 sending a DHCP discover message 611 to the DHCP server 602. If the DHCP server 602 is able to provide a connection to the WLAN for the DHCP client 601, a DHCP offer message 612 is transmitted to the DHCP client 601 in response to the DHCP discovery message 611.

The DHCP client 601 may transmit a DHCP Request message 613 to the DHCP server 602. The DHCP request message 613 may include information form the DHCP offer message 612 as needed. The DHCP server 602 sends a DHCP acknowledgement message 614 to complete the connection between the DHCP client and the WLAN.

The messages sent to the DHCP client 601 from the DHCP server 602 may include one or more network connection configuration parameters to be used by the DHCP client 601 when communicating over the WLAN. This configuration of the communications between the DHCP client 601 and the WLAN remains in effect for the time in which the DHCP client 601 remains attached to the WLAN.

As noted above, the connection of the DHCP client 601 with the WLAN is controlled by the DHCP server 602 using a DHCP lease for the connection. The DHCP lease provides a lease expiration date/time 622 after which the DHCP client 601 is required to reestablish a connection using a second DHCP request message 615 and receiving a second DHCP acknowledgement message 616. The reestablished connection includes a new IP address lease with a new expiration date/time with the above process repeating for as long as the DHCP client device 601 remains connected to the WLAN.

An issue may arise if the one or more network connection configuration parameters changes over time. As conditions and communication loads for data being transmitted over the various networks change, the networks may update the corresponding one or more network connection configuration parameters so as to support current operating conditions of the network. The updates to one or more network connection configuration parameters are typically communicated to the DHCP server 602 as part of a backhaul message 621 sent from a requesting network controller to the DHCP server in the wired and/or wireless access point.

Currently, the DHCP server 602 does not have a mechanism to update the one or more network connection configuration parameters in use by attached DHCP client devices 601. In order for the DHCP clients to receive the changed one or more network connection configuration parameters, the DHCP client 601 must disconnect and reconnect to the WLAN or the DHCP client must wait until the IP address lease expires and a new connection is initiated. During this time period, the DHCP client 601 continues to operate using the prior one or more network connection configuration parameters, which may result in failed communications leading to a disconnect and reconnect procedure. Such disconnect and reconnect procedures required to communicate updated communication parameters to a client device 601 delays communications until the procedure is completed, and thus may impact the user experience.

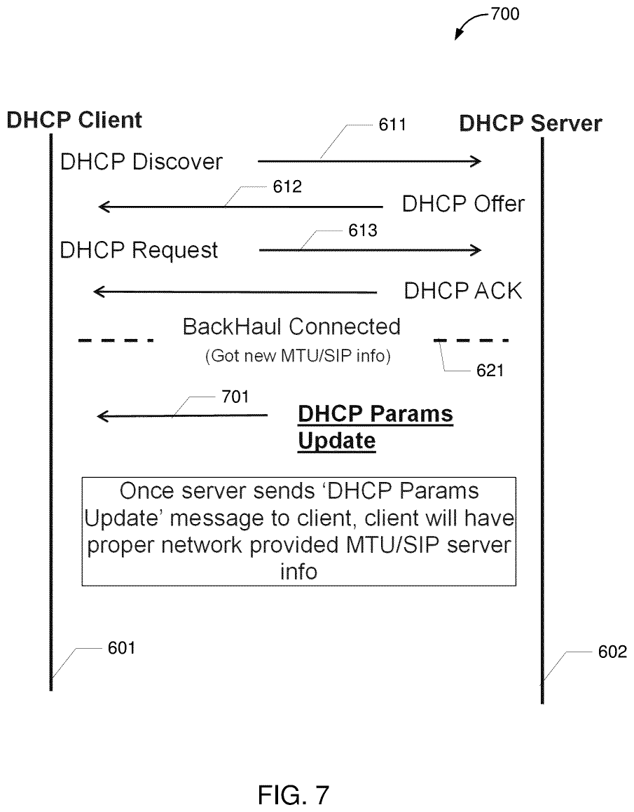

FIG. 7 is a message flow diagram illustrating operations for supporting wired and/or wireless local-area network management in accordance with various embodiments. With reference to FIGS. 1-7, a DHCP server 602 may improve the operation of the WLAN by using the message flow 700 shown in FIG. 7. A DHCP client 601 may connect to the WLAN using the existing sequence of DHCP discovery message 611, DHCP offer message 612, DHCP request message 613, and DHCP acknowledgement message 614 as described with reference to FIG. 6.

Using a network configuration parameters update command 701, the DHCP server 602 may update the one or more network connection configuration parameters used by the DHCP client 601 in response to a one or more network connection configuration parameters changing. The DHCP server 602 may generate the network configuration parameters update command 701 containing the updates to the one or more network connection configuration parameters and then send the generated network configuration parameters update command 701 to the DHCP client 601. Upon receipt of the network configuration parameters update command 701, the DHCP client 601 may change operating parameters of existing communications connections to conform to the update in the network configuration parameters update command 701. The DHCP client 601 may then use the updated network connection configuration parameters for communications via the WLAN without the interruption to update communication parameters described with reference to FIG. 6.

As noted, the processing system of the wired and/or wireless access point 501 may generate and send a network configuration parameters update command 701 to one or more of the attached client devices 502-505. The network configuration parameters update command 701 may include one or more data fields that are contained within the network configuration parameters update command 701 when transmitted. In some embodiments, the network configuration parameters update command 701 may be the same as the DHCP offer message 612 or a DHCP acknowledgement message 614 as described with reference to FIG. 6, with latest modified parameter information with a new DHCP message type as network configuration parameters update command 701.

When there is a change in DHCP configuration parameters, the DHCP server 602 may initiate a network configuration parameters update command 701 that is transmitted to the attached client devices in which the DHCP client 601 is running. The DHCP client 601 may decode this new DHCP configuration parameters update message and make necessary modifications in the communication devices (i.e., on the client side). The network configuration parameters update command 701 may include one or more data fields that are contained within the network configuration parameters update command 701 when transmitted. In some embodiments network configuration parameters update command 701 may be the same as the DHCP offer message 612 or DHCP acknowledgement message 614 with latest modified parameter information with a new DHCP message type as the network configuration parameters update command 701.

In some embodiments, DHCP server 602 also may initiate an update to the DHCP configuration parameters by sending a Discover, Offer, Request and Acknowledgement (DORA) initiate message including one field with value set to 1 which may cause the DHCP client 601 to perform a DORA connection process.

In the discover phase of the DORA connection process, the DHCP client 601 sends out a discover broadcast to the DHCP server 602. In response, the DHCP server 602 offers the DHCP client an available IP address to lease that includes the updated DHCP configuration parameters in the offer phase. The DHCP client then sends out a request broadcast in the request phase to accept a DHCP lease from the DHCP server 602 in the acknowledgement phase of the DORA connection process. The DHCP client 602 updates the DHCP configuration parameters as part of completing the DORA connection process.

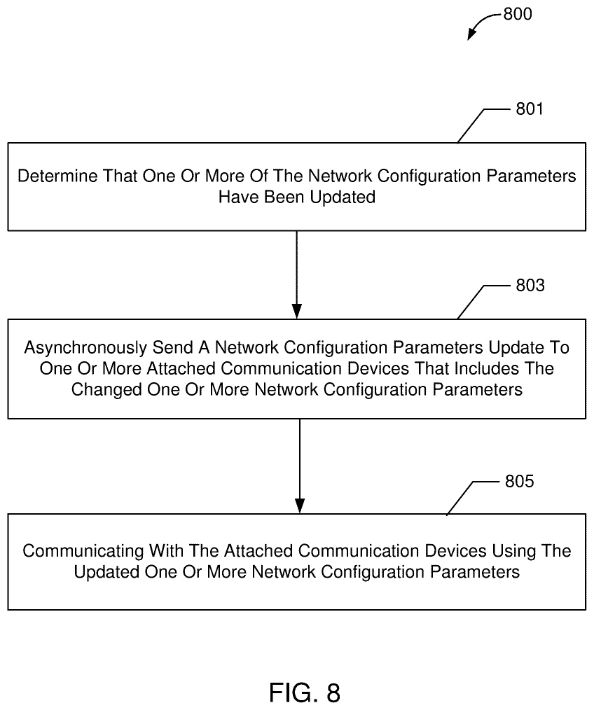

FIG. 8 is a process flow diagram illustrating a method 800 for supporting wired and/or wireless local-area network management in accordance with various embodiments. With reference to FIGS. 1-8, the operations of the method 800 may be implemented by a processing system including one or more processors of a communication device, such as the processor and modem components 200. Means for performing functions of the method 800 may include a wired and/or wireless access point processing system (e.g., 440) that includes one or more processors (e.g., 210, 212, 214, 216, 218) and supporting circuitry (e.g., 222, 224), electronic storage (e.g., 220, 438), and a wired and/or wireless transceiver (e.g., 403). To encompass the various processors and circuitry that may perform operations of the method 800, the operations of the method are described with reference to a “processing system.”

In block 801, the processing system determines that one or more of the network configuration parameters have been updated. This determination may be based upon receipt of a network operating parameter change for communications associated with one or more of the communication devices communicating via the wired and/or wireless access point 402. A network parameter change may be related to any operating parameter managed by the DHCP functionality within the wired and/or wireless access point 402. For example, the network parameters may include V4 IP, Netmask, lease time, DNS server, MTU, SIP server info, and related settings.

In block 803, the processing system may asynchronously send a network configuration parameters update command 701 to one or more attached communication devices 502-505 in response to determining that one or more of the network configuration parameters has been updated. The network configuration parameters update command 701 may be configured to update one or more network configuration parameters within the one or more attached communication devices 502-505 receiving the command. In some embodiments, the network configuration parameters update command 701 may be transmitted to the attached communication devices 502-505 contained within a unicast message transmitted to each of the attached communication devices 502-505. In some embodiments, the network configuration parameters update command 701 may be transmitted as a broadcast message sent to all connected devices communicating with the wired and/or wireless access point 402.

In block 805, the processing system communicates with the attached communication devices 502-505 using the changed one or more network configuration parameters after the network configuration parameters update command 701 has been sent by the wired and/or wireless access point 402, received and processed by the attached communication devices 502-505.

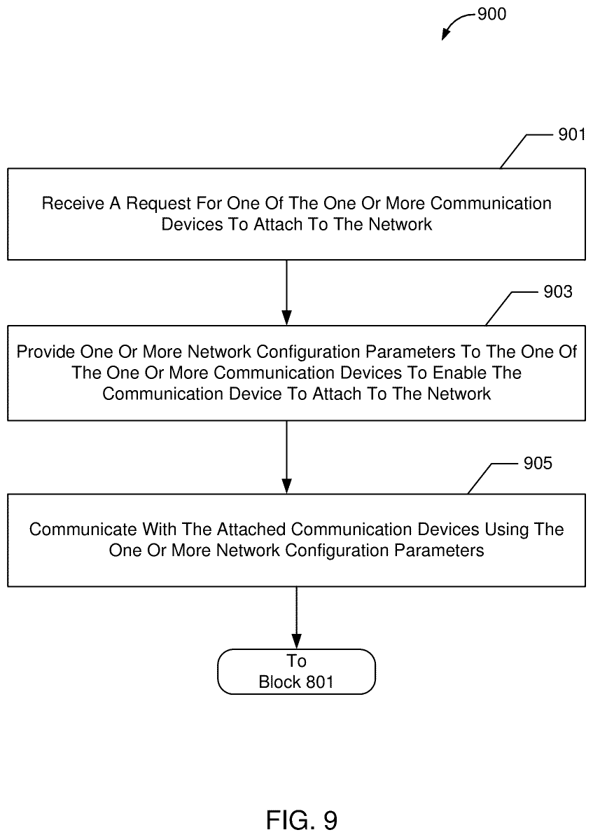

FIG. 9 is a process flow diagram illustrating a method 900 for supporting wired and/or wireless local-area network management in accordance with some embodiments. With reference to FIGS. 1-9, the operations of the method 900 may be implemented by one or more processors of a communication device, such as the processor and modem components 200. Means for performing functions of the method 900 may include a wired and/or wireless access point processing system (e.g., 440) that includes one or more processors (e.g., 210, 212, 214, 216, 218) and supporting circuitry (e.g., 222, 224), electronic storage (e.g., 220, 438), and a wired and/or wireless transceiver (e.g., 403). To encompass the various processors and circuitry that may perform operations of the method 900, the operations of the method are described with reference to a “processing system.”

In the method 900, a wireless communication device or a wired communication device attempts to become communicatively coupled to the wired and/or wireless access point 402 as part of the DHCP process. In block 901, the processing system of the wired and/or wireless access point 402 may receive a request from one of the communication devices 502-505 to attach to the WLAN 501.

In block 903, the processing system provides one or more network configuration parameters to the communication device to enable the communication device to attach to the WLAN. In some embodiments, the one or more network configuration parameters may all be transmitted to the communication device in a single command. In some embodiments, the one or more network configuration parameters may be transmitted to the communication device only when a network configuration parameter is used by the receiving communication device. In some embodiments, the one or more network configuration parameters may be transmitted to the communication device in a series of separate commands.

In block 905, the processing system may communicate with the attached communication devices 502-505 using the one or more network configuration parameters. Performing the operations in block 905 enables the communication device to become communicatively coupled to the WLAN network 501. The communication device may communicate over the WLAN network 501 using the one or more network configuration parameters until either the communication device detaches from the WLAN network or one or more network configuration parameters change. Having connected the communication device, the processing system may determine whether any of the network communication parameters have changed in block 801 and perform the operations of the method 800 as described.

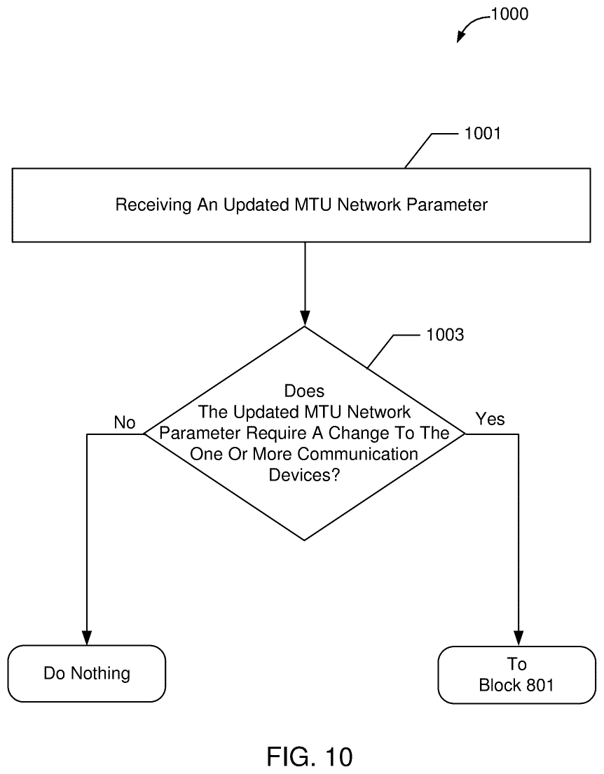

FIG. 10 is a process flow diagram illustrating a method 1000 for supporting wired and/or wireless local-area network management in accordance with some embodiments. With reference to FIGS. 1-10, the operations of the method 1000 may be implemented by a processing system including one or more processors of a communication device, such as the processor and modem components 200. Means for performing functions of the method 1000 may include a wired and/or wireless access point processing system (e.g., 440) that includes one or more processors (e.g., 210, 212, 214, 216, 218) and supporting circuitry (e.g., 222, 224), electronic storage (e.g., 220, 438), and a wired and/or wireless transceiver (e.g., 403). To encompass the various processors and circuitry that may perform operations of the method 1000, the operations of the method are described with reference to a “processing system.”

In the method 1000, an adjustment to an MTU network parameter is received and updated. The MTU network parameter determines the largest packet size that can be transmitted through your system. These packets are measured in octets, or eight-bit bytes. A larger MTU size results in an increase bulk protocol throughput for data transmitted through the wired and/or wireless access point 402. Fewer packets with the same amount of data are processed when the MTU size is increased. However, a tradeoff may occur that may lead to delays in subsequent packets, resulting in lags and minimum latency. A smaller MTU size results in more overhead and acknowledgements that must be sent and received as part of data communications through the wired and/or wireless access point 402.

In block 1001, the processing system of the wired and/or wireless access point 402 receives an updated MTU network parameter indicating a change in a maximum size for a transmitted data packet. A current MTU network parameter may be smaller than the received updated MTU network parameter value, which may have been configured for a particular WLAN network. Alternatively, a current MTU network parameter may be larger than the received updated MTU network parameter value, which may be in use by the WLAN network.

In determination block 1003, the processing system may determine whether the updated MTU network parameter requires a change to the communication parameters configured in one or more communication devices. current MTU network parameter value. In particular, the processing system may determine whether the change in the MTU network parameter needs to communicated to the other attached communication devices to enable communications over the WLAN network.

In response to determining that the updated MTU network parameter does not require a change to the one or more communication devices current MTU network parameter value (i.e., determination block 1002=“No”), the processing system may perform no operation, and wait for a change in one of the one or more network configuration parameters that may be detected in block 801 as described.

In response to determining that the updated MTU network parameter requires a change to the one or more communication devices current MTU network parameter value (i.e., determination block 1002=“Yes”), the processing system may update the MTU network parameter in the attached communication devices in block 803 of the method 800 as described. In particular, the processing system may format and send a network configuration parameters update command 701 that updates the attached communication devices 502-505 to send and receive data packets conforming to the maximum size contained within the updated MTU network parameter.

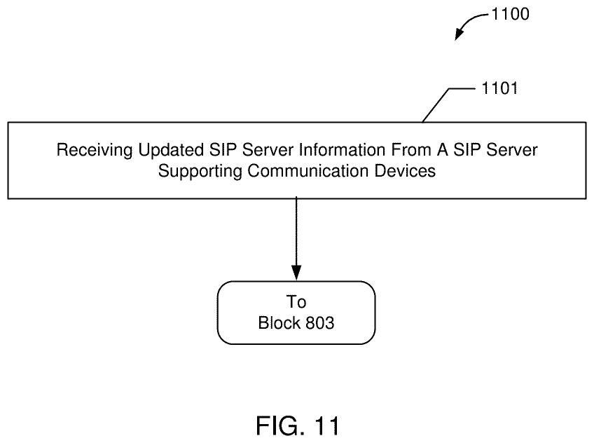

FIG. 11 is a process flow diagram illustrating a method 1100 for supporting wired and/or wireless local-area network management in accordance with some embodiments. With reference to FIGS. 1-11, the operations of the method 1100 may be implemented by a processing system including one or more processors of a communication device, such as the processor and modem components 200. Means for performing functions of the method 1100 may include a wired and/or wireless access point processing system (e.g., 440) that includes one or more processors (e.g., 210, 212, 214, 216, 218) and supporting circuitry (e.g., 222, 224), electronic storage (e.g., 220, 438), and a wired and/or wireless transceiver (e.g., 403). To encompass the various processors and circuitry that may perform operations of the method 1100, the operations of the method are described with reference to a “processing system.”

In the method 1100, an SIP server may be used to establish Voice over IP (VOIP) communications between a communication device and a remote computing device. The SIP server and the communication device and remote devices establishing a VoIP session use the Session Initiation Protocol (SIP), which is a signaling protocol used for initiating, maintaining, and terminating communication sessions that include voice, video and messaging applications. SIP defines the specific format of messages exchanged and the sequence of communications for cooperation of the participants. SIP is a text-based protocol, incorporating many elements of the Hypertext Transfer Protocol (HTTP) and the Simple Mail Transfer Protocol (SMTP). SIP is used in Internet telephony, in private IP telephone systems, and mobile phone calling over LTE (VOLTE). A call established with SIP may consist of multiple media streams, but no separate streams are required for applications, such as text messaging, that exchange data as payload in the SIP message.

SIP protocol works in conjunction with several other protocols that specify and carry the session media. Most commonly, media type and parameter negotiation and media setup are performed with the Session Description Protocol (SDP), which is carried as the payload in SIP messages. SIP is designed to be independent of the underlying transport layer protocol and can be used with the User Datagram Protocol (UDP), the Transmission Control Protocol (TCP), and the Stream Control Transmission Protocol (SCTP). For secure transmissions of SIP messages over insecure network links, the protocol may be encrypted with Transport Layer Security (TLS). For the transmission of media streams (voice, video) the Session Description Protocol (SDP) payload carried in SIP messages typically employs the Real-time Transport Protocol (RTP) or the Secure Real-time Transport Protocol (SRTP).

In block 1101, the processing system receives an update to SIP server information that has been configured to permit attached communication devices 502-505 to establish a VoIP session. This SIP server information is used by communication devices when establishing a VoIP connection.

The DHCP server 602 may process the updated info and send it to all connected DHCP clients via configuration update message, irrespective of whether the DHCP server 602 supports the modified parameter. As the DHCP server 602 is operating at a DHCP protocol level, the provision of updates to DHCP configuration parameters may be provided to the DHCP client 601 permitting the DHCP client 601 to use the updated parameters when appropriate. Thereafter, the processing system may update the MTU network parameter in the attached client devices in block 803 of the method 800 as described.

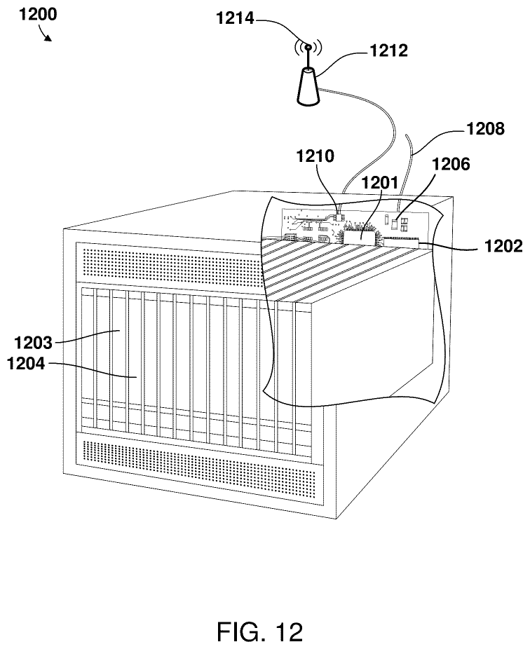

Various embodiments may be implemented in a variety of wired and/or wireless network devices, an example of which is illustrated in FIG. 12 in the form of a wired and/or wireless network computing device 1200 functioning as a network element of a communication network, such as a wired and/or wireless access point or a base station. Such network computing devices may include at least the components illustrated in FIG. 12. With reference to FIGS. 1-12, the network computing device 1200 may typically include a processor 1201 coupled to volatile memory 1202 and a large capacity nonvolatile memory, such as a disk drive 1203. The network computing device 1200 may also include a peripheral memory access device such as a floppy disc drive, compact disc (CD) or digital video disc (DVD) drive 1204 coupled to the processor 1201. The network computing device 1200 may also include network access ports 1206 (or interfaces) coupled to the processor 1201 and configured for establishing wired data connections with a network, such as the Internet, and/or support a local area network coupled to communication devices. The network computing device 1200 may also include a wireless network access port 1210 coupled to the processor 1201 and configured for establishing wireless data communication links with wireless communication devices in a local wireless network, such as via one or more wireless access points 1212 that includes one or more antennas 1214 for sending and receiving electromagnetic radiation with connected wireless communication devices. The network computing device 1200 may include additional access ports, such as USB, Firewire, Thunderbolt, and the like for coupling to peripherals, external memory, and/or other computing devices.

The processing system in a wired and/or wireless access point may include any programmable microprocessor, microcomputer or multiple processor chip or chips that can be configured by software instructions (applications) to perform a variety of functions, including the functions of various embodiments as described. In some embodiments, the processing system may include multiple processors, such as one processor dedicated to wireless communication functions and one processor dedicated to running other applications. Typically, software applications may be stored in the internal memory 1206 before they are accessed and loaded into the processors 1201. The processors 1201 may include internal memory sufficient to store the application software instructions. In many devices the internal memory may be a volatile or nonvolatile memory, such as flash memory, or a mixture of both. For the purposes of this description, a general reference to memory refers to memory accessible by the processors 1201, including internal memory or removable memory plugged into the device and memory within the processor 1201, themselves.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and a processing system executing the application on the computing device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

A number of different cellular and mobile communication services and standards are available or contemplated in the future, all of which may implement and benefit from the various embodiments. Such services and standards include, e.g., third generation partnership project (3GPP), long term evolution (LTE) systems, third generation wireless mobile communication technology (3G), fourth generation wireless mobile communication technology (4G), fifth generation wireless mobile communication technology (5G), global system for mobile communications (GSM), universal mobile telecommunications system (UMTS), 3GSM, general packet radio service (GPRS), code division multiple access (CDMA) systems (e.g., cdmaOne, CDMA1020™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only and are not intended to limit the scope of the claims to a particular communication system or technology unless specifically recited in the claim language.

Implementation examples are described in the following paragraphs. While some of the following implementation examples are described in terms of example methods, further example implementations may include the example methods discussed in the following paragraphs implemented by a DHCP server within a wired and/or wireless access device including a processor configured with processor-executable instructions to perform operations of the methods of the following implementation examples; example methods discussed in the following paragraphs implemented by a DHCP server within a wired and/or wireless access device including means for performing functions of the methods of the following implementation examples; and example methods discussed in the following paragraphs may include a DHCP server within a wired and/or wireless access device that may be implemented as a non-transitory processor-readable storage medium having stored thereon processor-executable instructions configured to cause a DHCP processor to perform the operations of the methods of the following implementation examples.

Example 1. A method performed by a DHCP server in a network access point for configuring one or more communication devices communicatively coupled to a local area network, including: determining that network configuration parameter has been updated; asynchronously sending a network configuration parameters update to one or more client devices attached to the local area network including the updated one or more network configuration parameters; and communicating with the communication devices attached to the local area network using the updated one or more network configuration parameters.

Example 2. The method of example 1, in which the one or more network configuration parameters is one or more of V4 Internet Protocol (IP), Netmask, lease time, time zone, domain name system (DNS) server, maximum transmission unit (MTU), or Session Initiation Protocol (SIP) server info.

Example 3. The method of example 2, further including: receiving an updated MTU network parameter; and determining whether the updated MTU network parameter requires a change to one or more communication devices, in which asynchronously sending a network configuration parameters update to one or more communication devices attached to the local area network is performed in response to determining that the updated MTU network parameter requires a change to one or more communication devices, and in which the updated one or more network configuration parameters is the updated MTU network parameter.

Example 4. The method of example 2, in which the updated one or more network configuration parameters includes updated SIP server information received from a remote server.

Example 5. The method of any of examples 1-4, in which asynchronously sending the network configuration parameters update to communication devices attached to the local area network includes sending a single command to all communication devices attached to the local area network.

Example 6. The method of example 5, in which the network configuration parameters update includes a DHCP ACK message.

Example 7. The method of any of examples 1-4, in which asynchronously sending the network configuration parameters update includes sending a broadcast message for reception by all communication devices attached to the local area network.

Example 8. The method of any of examples 1-4, in which the network configuration parameters update is sent using a connection between the DHCP server and the one or more communication devices attached to the local area network, the connection including at least one of a wireless communication link, an Ethernet link, or a universal serial bus (USB) link.

Example 9. The method of any of examples 1-4, in which asynchronously sending a network configuration parameters update to one or more communication devices attached to the local area network includes: sending a network message configured to cause the one or more communication devices attached to the local area network to initiate a Discover, Offer, Request and Acknowledgement (DORA) connection process with the DHCP server; and responding to the DORA connection process to asynchronously send the network configuration parameters update to the one or more communication devices attached to the local area network.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods 700, 800, 900, 1000, and/or 1100 may be substituted for or combined with one or more operations of the methods 700, 800, 900, 1000, and/or 1100.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present invention is not intended to be limited to the embodiments shown herein but is to be accorded the widest scope consistent with the following claims and the principles and novel features disclosed herein.

1. A method performed by a Dynamic Host Configuration Protocol (DHCP) server in a network access point for configuring one or more communication devices communicatively coupled to a local area network, comprising:
determining that one or more network configuration parameters have been updated, wherein the updated one or more network configuration parameters comprise:
an updated maximum transmission unit (MTU) network parameter; or
updated Session Initiation Protocol (SIP) server information;
asynchronously sending a network configuration parameters update to one or more communication devices attached to the local area network, the network configuration parameters update comprising:
the updated MTU network parameter; or
the updated SIP server information; and
communicating with the attached communication devices using the updated one or more network configuration parameters.

2. The method of claim 1, wherein the updated one or more network configuration parameters comprises one or more of V4 Internet Protocol (IP), Netmask, lease time, time zone, or domain name system (DNS) server.

3. The method of claim 1, further comprising:
receiving the updated MTU network parameter; and
determining whether the updated MTU network parameter requires a change to one or more communication devices,
wherein asynchronously sending a network configuration parameters update to one or more communication devices attached to the local area network is performed in response to determining that the updated MTU network parameter requires a change to one or more communication devices.

4. The method of claim 1, further comprising receiving the updated SIP server information from a remote server.

5. The method of claim 1, wherein asynchronously sending the network configuration parameters update to communication devices attached to the local area network comprises sending a single command to all communication devices attached to the local area network.

6. The method of claim 5, wherein the network configuration parameters update comprises a DHCP ACK message.

7. The method of claim 1, wherein asynchronously sending the network configuration parameters update comprises sending a broadcast message for reception by all communication devices attached to the local area network.

8. The method of claim 1, wherein the network configuration parameters update is sent using a connection between the DHCP server and the one or more communication devices attached to the local area network, the connection comprising at least one of a wireless communication link, an Ethernet link, or a universal serial bus (USB) link.

9. The method of claim 1, wherein asynchronously sending a network configuration parameters update to one or more communication devices attached to the local area network comprises:
sending a network message configured to cause the one or more communication devices attached to the local area network to initiate a Discover, Offer, Request and Acknowledgement (DORA) connection process with the DHCP server; and
responding to the DORA connection process to asynchronously send the network configuration parameters update to the one or more communication devices attached to the local area network.

10. A network access point, comprising:
a transceiver configured to support communications of a local area network with one or more communication devices; and
a processing system coupled to the transceiver, wherein at least one processor of the processing system is configured to function as a Dynamic Host Configuration Protocol (DHCP) server and to:
determine that one or more network configuration parameters have been updated, wherein the updated one or more network configuration parameters comprise:
an updated maximum transmission unit (MTU) network parameter; or
updated Session Initiation Protocol (SIP) server information;
asynchronously send a network configuration parameters update to one or more communication devices attached to the local area network, the network configuration parameters update comprising:
the updated MTU network parameter; or
the updated SIP server information; and
communicate with the attached communication devices using the updated one or more network configuration parameters.

11. The network access point of claim 10, wherein the updated one or more network configuration parameters is comprises one or more of V4 Internet Protocol (IP), Netmask, lease time, time zone, or domain name system (DNS) server.

12. The network access point of claim 10, wherein the at least one processor is further configured to:
receive the updated MTU network parameter;
determine whether the updated MTU network parameter requires a change to one or more communication devices; and
asynchronously send the network configuration parameters update to one or more communication devices attached to the local area network in response to determining that the updated MTU network parameter requires a change to one or more communication devices.

13. The network access point of claim 10, wherein the at least one processor is further configured to receive the updated SIP server information from a remote server.

14. The network access point of claim 10, wherein the at least one processor is further configured to send a single command to all communication devices attached to the local area network.

15. The network access point of claim 14, wherein the network configuration parameters update comprises a DHCP ACK message.

16. The network access point of claim 10, wherein the at least one processor is further configured to send the network configuration parameters update as a broadcast message for reception by all communication devices attached to the local area network.

17. The network access point of claim 10, wherein the at least one processor is further configured to send using a connection between the DHCP server and the one or more communication devices attached to the local area network, the connection comprising at least one of a wireless communication link, an Ethernet link, or a universal serial bus (USB) link.

18. The network access point of claim 10, wherein the at least one processor is further configured to send a network configuration parameters update to one or more communication devices attached to the local area network by:
sending a network message configured to cause the one or more communication devices attached to the local area network to initiate a Discover, Offer, Request and Acknowledgement (DORA) connection process with the DHCP server; and
responding to the DORA connection process to asynchronously send the network configuration parameters update to the one or more communication devices attached to the local area network.

19. A non-transitory processor-readable medium having stored thereon processor-executable instructions configured to cause at least one processor of a network access point to perform operations comprising:
determining that one or more network configuration parameters have been updated, wherein the updated one or more network configuration parameters comprise:
an updated maximum transmission unit (MTU) network parameter; or
updated Session Initiation Protocol (SIP) server information;
asynchronously sending a network configuration parameters update to one or more communication devices attached to a local area network, the network configuration parameters update comprising:
the updated MTU network parameter; or
the updated SIP server information; and
communicating with the attached communication devices using the updated one or more network configuration parameters.

20. The non-transitory processor-readable medium of claim 19, wherein the stored processor-executable instructions are configured to cause the at least one processor of the network access point to perform operations such that asynchronously sending a network configuration parameters update to one or more communication devices attached to the local area network comprises:
sending a network message configured to cause the one or more communication devices attached to the local area network to initiate a Discover, Offer, Request and Acknowledgement (DORA) connection process with a DHCP server; and
responding to the DORA connection process to asynchronously send the network configuration parameters update to the one or more communication devices attached to the local area network.
